(19) United States
(12) Patent Application Publication
(10) Pub. No.: US 2026/0280127 A1
(43) Pub. Date: Sep. 17, 2026

(54) VARIABLE DIELECTRIC BASED ANTENNA WITH HYDRAULIC KNOCK SYSTEM

(71) Applicant: SDEROTECH, INC., Kiryat Bialik (IL)

(72) Inventors: Dedi David Haziza, Kiryat Motzkin (IL); Vladimir Alperovich, Modiin Ilit (IL)

(21) Appl. No.: 19/077,984

(22) Filed: Mar. 12, 2025

(51) Int. Cl. H01Q 9/04; F16F 15/027

(52) U.S. Cl. CPC H01Q 9/0407; F16F 15/027; F16F 2230/18; F16F 2230/22

(57) ABSTRACT

Natural response time for domains to assume their natural relaxed state is accelerated by forcing the domains to assume the natural state using hydraulic knock. The hydraulic knock may be implemented by causing VDC material flow within the VDC plate. Flow can be achieved by forming inlet ports and outlet ports in the VDC plate, and controlling VDC fluid flow into the inlet port using an inlet valve and fluid flow out of the outlet port using an outlet valve. Pressure differential is maintained upstream of the inlet valve and downstream of the outlet valve. By controlling the opening duration and amount of the inlet and outlet valve, flow of VDC material within the VDC plate can be induced. This flow is believed to knock the domains out of alignment to thereby accelerate the relaxation time of the domains.

### FIELD

The subject disclosure relates to improvements in response time of liquid crystal domains more specifically addressing the inherent long fall time of a the liquid crystal molecules that aren't under the effect of an electrical field, the presented apparatus and method are especially beneficial when used in conjunction with electronic devices, adaptive RF devices, such as, e.g., variable dielectric constant (VDC) antennas and devices and electromagnetic signal transmission elements and non-transmission elements i.e., connected devices.

### BACKGROUND

The subject applicant has previously disclosed various mechanisms for improved control of the orientation of liquid crystal domains, see, e.g., U.S. Pat. No. 10,705,391 and U.S. Publication no. 2023/0187836. The disclosed embodiments in these references utilize mechanisms such as application of electric field and/or magnetic field; application of mechanical, hydraulic or sonic pressure; or incorporation of RF choke and/or RF traps to enable rapid placement of the domain system in a desired state.

As explained in U.S. Pat. No. 10,705,391, when an appropriate electrical field is applied, the molecules (domains) rotate an amount that correlates with the strength of the applied field, and when the field is removed the molecules return to their relaxed state. However, the domains'temporal response to application of the field, i.e., “turning on” or aligning the domains, is much faster than the temporal response to removal of the field, i.e., “turning off” or relaxing the domains to an unaligned orientation. In certain applications, such as those disclosed in U.S. Pat. Nos. 7,466,269, 7,884,766 and 10,199,710, it is highly desirable to have the turn off response time at speeds similar or as close as possible to the turn on response time.

Embodiments disclosed in U.S. Publication 2023/0187836 include the introduction of static hydraulic pressure inside the VDC structure during fabrication. The hydraulic pressure remains within the VDC structure after sealing the liquid injection port, such that the nematic domains remain constantly under static hydraulic pressure. By maintaining the domains under static hydraulic pressure, the relaxation process is accelerated.

The subject inventors have undertaken further research to further enhance accelerated relaxation time of the domain within the VDC structure. This issue is a fundamental challenge to the implementation of fast scanning VDC-based antenna and other VDC devices requiring rapid change of the dielectric constant.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Disclosed embodiments accelerate the response time of domains within a variable dielectric constant (VDC) layer, hence enabling rapid change of the dielectric constant within the device or antenna. The embodiments specifically address the slow natural response time when an aligning electric field (“turn on”) is removed or lowered, whereby the domains return towards their natural relaxed state, in which the domains are not aligned and are randomly oriented with respect to each other. The slow relaxation time is more pronounced specifically in a large cell gap where the fall time i.e., T_{fall}, is much longer and may be in the range of seconds. As disclosed herein, this natural relaxation time is accelerated by the application dynamic hydraulic pressure pulse, referred to herein as hydraulic knock. As would be further described below, the pressure pulse can be thought of as a flow wave through the VDC layer. Incidentally, any of the disclosed embodiments may additionally incorporate an RF choke and/or one or more RF traps, as disclosed in U.S. Publication 2023/0187836.

Disclosed embodiments are applicable to any system having orientable domains, wherein natural relaxation time is significantly longer the on-set response to an applied field. Such systems include, e.g., electrical transmission systems and optical systems. The change in orientation of the orientable domain causes a change in the dielectric constant of the system and a change is the optical transmission characteristics of the system, e.g., from opaque to transparent. The changes in the dielectric constant and optical characteristics are concurrent, so for simplicity, much of the discussion herein will refer to changes in dielectric constant, but the discussion is equally applicable to optical characteristic changes.

Thus, an orientable domain system is disclosed, comprising an orientable domain fluid encased within an encasement, a fluid inlet attached to the encasement and oriented to inject orientable domain fluid into the encasement; an outlet port attached to the encasement and oriented to eject orientable domain fluid from the encasement. The system may further include an inlet valve controlling flow into the inlet port; an outlet valve controlling flow out of the outlet port; and a pump maintaining pressure differential between the inlet port and the outlet port.

An electronic transmission device transmitting electrical signals is disclosed, comprising: a variable dielectric constant (VDC) plate comprising variable VDC material sandwiched between a bottom dielectric plate and a top dielectric plate, the VDC material having plurality of orientable domains; a common potential plate positioned adjacent the bottom dielectric plate; a plurality of delay lines positioned above the top dielectric plate, each delay line transmitting RF signals; and at least one input hydraulic port enabling injection of VDC fluid into the VDC plate and at least one output hydraulic port enabling ejection of VDC fluid out of the VDC plate. Embodiment wherein the electronic transmission apparatus is an antenna, the apparatus further comprises a plurality of radiators, each radiator paired with a corresponding one of the plurality of delay lines.

Disclosed embodiments include a scanning antenna, comprising: a variable dielectric constant (VDC) plate having an inlet port and an outlet port; a plurality of RF radiators arranged as an array above the VDC plate; a plurality of delay lines, each coupled to and communicating RF signal with a corresponding one of the plurality of RF radiators; an inlet fluid line coupled to the inlet port and an outlet fluid line coupled to the outlet port; and a pump coupled to, and maintaining a pressure differential between, the inlet fluid line and outlet fluid line.

Also, an antenna is disclosed, comprising: a variable dielectric constant (VDC) plate having a top dielectric plate, a bottom dielectric plate, a variable dielectric material between the top and bottom dielectric plates, an inlet port and an outlet port enabling fluid flow to the variable dielectric material; a common potential plate provided adjacent the bottom dielectric plate; a plurality of radiators; a plurality of transmission lines provided above the top dielectric plate, each of the transmission lines coupled to one of the radiators and to an RF port.

Additionally, a method of operating a transmission device having conductors provided over a variable dielectric constant plate is disclosed, comprising: applying signals to at least a first subset of the conductors to cause transmission of the signals; applying control signal to at least a second subset of the conductors to cause domains within the variable dielectric constant plate to align according to field generated by the control signal; stopping application of the control signal to thereby cause the domain to relax to natural orientation, while simultaneously causing fluid flow within the domains to thereby accelerate time required for the domains to relax to natural orientation.

### BRIEF DESCRIPTION OF THE DRAWINGS

Other aspects and features of the invention would be apparent from the detailed description, which is made with reference to the following drawings. It should be appreciated that the detailed description and the drawings provides various non-limiting examples of various embodiments of the invention, which is defined by the appended claims.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1A is a top view of an orientable domain system showing domain control according to an embodiment, while FIG. 1B illustrates a cross-section along line A-A in FIG. 1A, also referred to herein as a hydraulic knock system.

FIG. 2 is a sketch of an embodiment of a system for introducing VDC material flow within the VDC structure to reduce the relaxation time of the domains within the VDC material.

FIG. 3 is a top view of an embodiment of an antenna adaptable to implementing hydraulic knock system.

FIG. 4A illustrates a top view of a single radiating element 410, while FIG. 4B illustrates a cross section of relevant sections of the antenna at the location of the radiating element 410 of FIG. 4A.

### DETAILED DESCRIPTION

Embodiments of the inventive system and method for improving response time of variable dielectric constant will now be described with reference to the drawings. Different embodiments or their combinations may be used for different applications or to achieve different benefits. Depending on the outcome sought to be achieved, different features disclosed herein may be utilized partially or to their fullest, alone or in combination with other features, balancing advantages with requirements and constraints. Therefore, certain benefits will be highlighted with reference to different embodiments, but are not limited to the disclosed embodiments. That is, the features disclosed herein are not limited to the embodiment within which they are described, but may be “mixed and matched” with other features and incorporated in other embodiments.

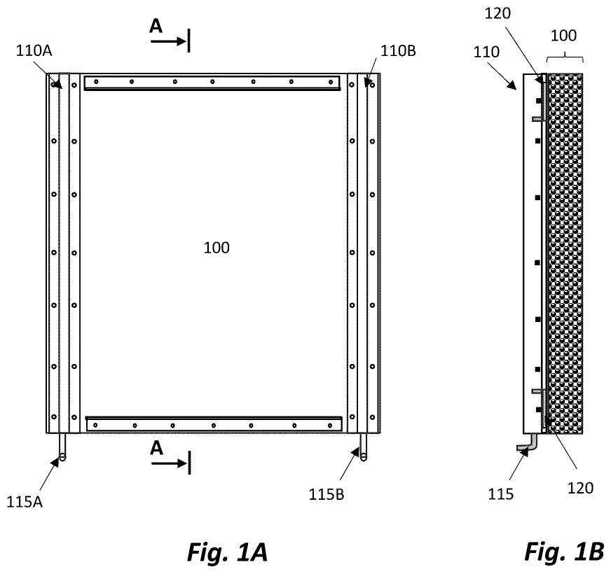

FIG. 1A is a general schematic of an orientable domain system, which may be used for controlling its electrical and/or optical characteristics. In one example, the system may be, e.g., a part of an electronic device, e.g., a VDC-based transmission devices such as, e.g., an antenna, showing domain control using dynamic hydraulic pressure according to an embodiment, while FIG. 1B illustrates a view along line A-A of FIG. 1A. The view in FIG. 1A may be a top view or a bottom view, depending on the design of the device, but in this discussion, for simplicity, it will be assumed that it's a bottom view of an orientable domain system such as a VDC-based antenna. The orientable domain fluid is encased within an encasement, which in one example is a VDC-structure, also referred to herein as VDC-plate, and is referenced as element 100. When the system is an electrical transmission system, its general structure may encompass any of the structures disclosed in the above-cited references. This structure may incorporate an orientable domain fluid encased within an encasement, which may include a bottom plate and a top plate, which, depending on the application, may be transparent or non-transparent. When the system is a transmission device, such as an RF transmission device, it may also include transmission elements such as bends, power splitters, filters, ports, phase shifters, frequency shifters, attenuators, couplers, capacitors, inductors, diplexers, hybrids of beam forming networks, as disclosed in, e.g., above-cited U.S. Pat. No. 10,199,710.

In the specific, non-limiting illustrated example, the encasement, e.g., a VDC plate, 100 is coupled to fluid distribution ducts 110, wherein fluid distribution duct 110A is an inlet duct and fluid distribution duct 110B is an outlet duct. Inlet duct 110A is connected to inlet conduit 115A, while outlet duct 110B is connected to outlet conduit 115B, wherein each of the conduits 115 may be a hose, a pipe, etc., suitable for transport of orientable domain fluid, e.g., VDC material therein, such as liquid crystal, e.g., nematic liquid crystals used in traditional liquid crystal displays (LCD). The VDC material may include liquid crystals within solvent, e.g., water. The encasement 100 includes ports 120, e.g., inlet ports and outlet ports, which are fluidly coupled to the inlet and outlet ducts 110A and 110B. Thus, VDC material flowed in from inlet conduit 115A flows in the inlet duct 110A, thence through the inlet port 120 into the VDC-structure, while at the same time the same amount of VDC material flows from the VDC structure via the outlet port and into the outlet duct 110B and thence to outlet conduit 115B.

Starting from relax state, when a change in the dielectric constant or optical properties of the VDC structure is desired, an electric field is applied across the VDC structure by an electric field applicator, as explained in any of the above cited publications. This causes domains in the VDC structure to align according to the applied electric field. When the electric field is removed, the domains return to their relax state. It is discovered by the subject inventors that if upon removal or change of the electric field a short burst of VDC material flow is generated within the VDC structure, the process of relaxation is expedited. It is believed that the short burst of flow jolts the domain within the VDC structure and thereby shortens the natural relaxation time. In the embodiment disclosed herein, the burst of flow is caused by flowing VDC material into the VDC structure from the inlet port, while at the same time allowing flow of VDC material out of the VDC structure via the outlet port. The flow is rather instantaneous, i.e., one or more short bursts of flow.

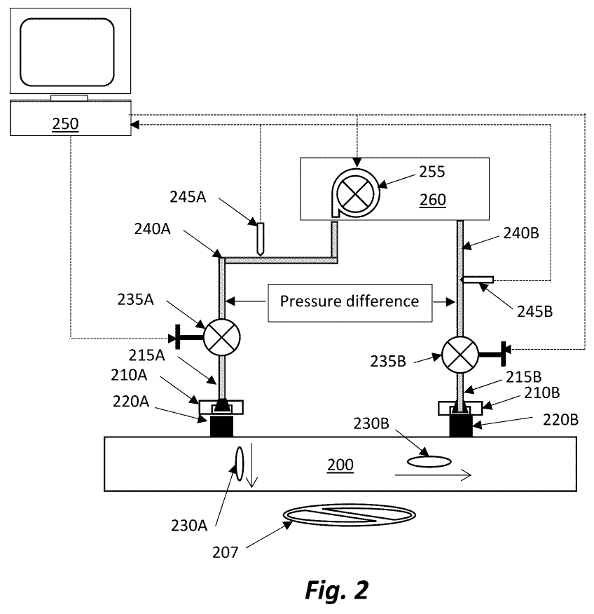

FIG. 2 is a sketch of an embodiment of a system for introducing orientable domain fluid, e.g., VDC material, flow within the orientable domain structure to accelerate and reduce the relaxation time of the domains within the orientable domain fluid material. The sketch is simplified in order to highlight the relevant features involved in creating the busts of orientable domain fluid material flow. As with the embodiment of FIGS. 1A and 1B, the orientable domain fluid encasement 200 includes an inlet port 220A and an outlet port 220B. Orientable domain 230A is illustrated in a vertical orientation to symbolize an aligned state caused by the application of electrical field, while orientable domain 230B is illustrated in a horizontal orientation to symbolize a relaxed state. Of course, the domains may assume any other orientations.

To effectuate the flow, the inlet port 220A is coupled by the inlet duct 210A to inlet conduit 215A. Inlet conduit 215A is coupled to inlet valve 235A, which is coupled to reservoir 260 via supply line 240A and pump 255. The outlet port 220B is coupled by the outlet duct 210B to outlet conduit 215B. Outlet conduit 215B is coupled to outlet valve 235B, which is coupled to reservoir 260 via return line 240B. Pump 255 maintains a pressure differential between the pressure inside supply line 240A and the pressure inside the return line 240B, wherein the pressure inside supply line 240A is higher than the pressure inside return line 240B. Thus, if inlet valve 235A and outlet valve 235B are opened simultaneously, orientable domain material will flow from the reservoir into the encasement 200 via the inlet port, and will flow out of the encasement to the reservoir 260 via the outlet port. In the depicted embodiment the operation of the inlet valve 235A, outlet valve 235B and pump 255 is controlled by controller 250. Also, optionally, one or more pressure sensors 245A, 245B, measure pressure in either or both the supply line 240A and/or return line 240B to enable precise control of the pump to provide precise pressure differential between the supply line 240A and return line 240B.

During application of electrical field by the electric field applicator, here symbolized by element 207, the valves are closed and no flow is introduced into the encasement 200. Upon stoppage of the electrical field, a short pulse or burst of flow is introduced by applying one or several short activation pulses to both valves 235A and 235B simultaneously. Thereafter, the valves 235A and 235B remain closed until the next stoppage of electrical field. In essence, a method for accelerating relaxation time in a polarized domain system is provided, comprising simultaneously upon termination or reduction of an applied electric field, introducing momentary or pulsed flow of polarized domain liquid within the system.

In the described example, when the system is implemented as an RF transmission antenna, the following values would be beneficial for smooth operation; however, these values are provided just as examples and other values can be implemented and can yield dramatically faster response time than natural relaxation. The VDC material's dynamic viscosity for this example may be at from 9 up to and including 50 mPa*s (millipascal-second) at 60° C. Duration of the specific valve opening at about 5 to 40 milliseconds, e.g., 20 milliseconds, with flow rate of 1-10 microliters per minute (μl/m) or a flow rate of 0.1 cc/s to 10 cc/s inclusive. Pressure differential between supply and return lines in some examples was about 0.01 millibar-1.5 bars. By implementing the disclosed embodiment, natural relaxation time, T_{fall}, of about 30 seconds can be reduced to 20-40 milliseconds. Also, in the sample the flow can be between 0.1 cc/s to 10 cc/s (depends on pressure difference between ducts). This flow is for gap of 100 μm between the plates. For LCD, where gap is only about 0.3 μm, the flowrate must be significantly less, but pressure is higher.

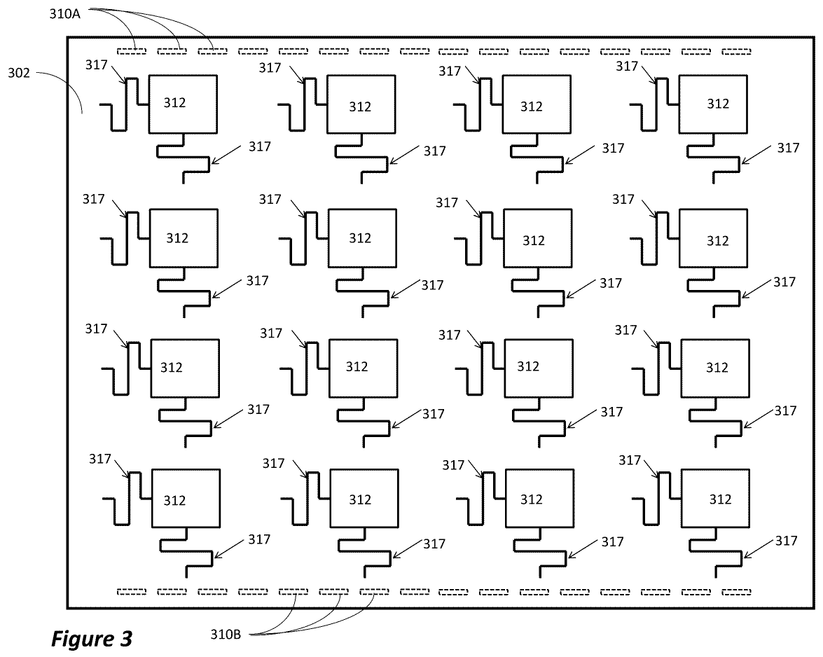

FIG. 3 is a top view of an embodiment of an antenna adaptable to implementing hydraulic knock system. The antenna in this particular example comprises a 4×4 array of radiators 312, although any number of radiators in various geometries and arrangements may be used, and a square arrangement of 4×4 elements is chosen only as but one example. In this example each radiator 312 is a conductive patch provided (e.g., deposited, adhered to, or printed) on top of an insulation layer 302 and has delay feed lines 317 coupled to it, either physically or RF capacitively. Each delay feed line 317 is a conductor that provides the RF signal to its corresponding patch 312. The RF signal can be manipulated, e.g., delayed, change frequency, change phase, by controlling a variable dielectric layer positioned under the insulation layer 302. By controlling all of the delay lines, the array can be made to point to different directions, as needed, thus providing a scanning array. As illustrated in dotted lines, in this example the inlet port is fabricated in a form of a series of inlet slots 310A which, when assembled, are connected to an inlet manifold or fluid distribution duct (obscured in this view). Similarly, the outlet port is fabricated in a form of a series of outlet slots 310B which, when assembled, are collectively connected to an outlet manifold or fluid distribution duct (obscured in this view).

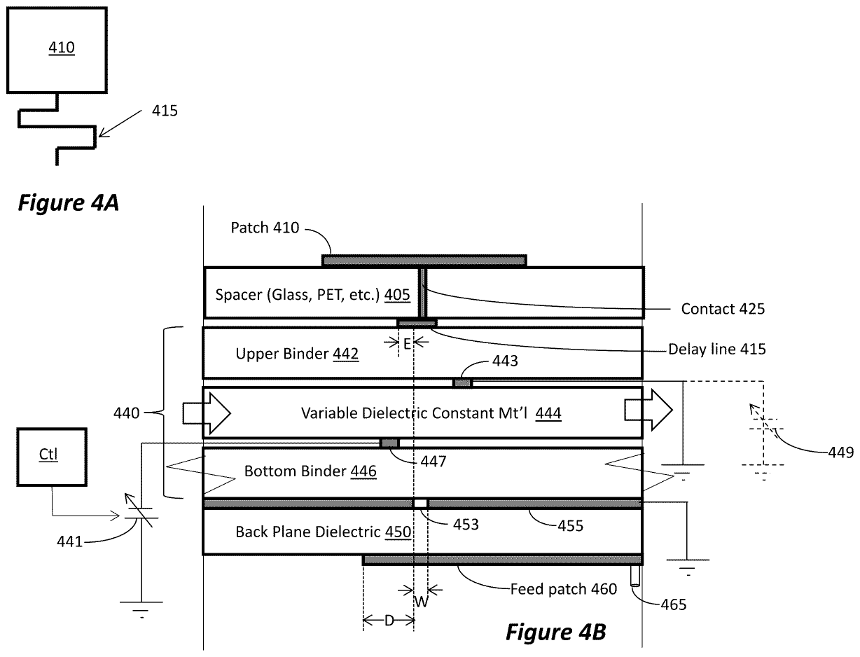

For completeness, the structure and operation of the VDC-based antenna can be better understood from the following description of FIGS. 4A and 4B. FIG. 4A illustrates a top view of a single radiating element 410, e.g., one of the radiating elements 312 shown in FIG. 3, while FIG. 4B illustrates a cross section of relevant sections of the antenna at the location of the radiating element 410 of FIG. 4A. The structure is the same for all other radiating elements in the antenna array, so the break lines in FIG. 4B indicates that a small section of the entire device is illustrated.

A top dielectric spacer 405 is generally in the form of a dielectric (insulating) plate or a dielectric sheet, and may be made of, e.g., glass, PET, etc. The radiating patch 410 is formed over the spacer by, e.g., adhering a conductive film, sputtering, printing, etc. At each patch location, a via is formed in the dielectric spacer 405 and is filled with conductive material, e.g., copper, to form contact 425, which connects physically and electrically to radiating patch 410. A delay line 415 is formed on the bottom surface of dielectric spacer 405 (or on top surface of upper binder 442), and is connected physically and electrically to contact 425. That is, there is a continuous DC electrical connection from the delay line 415 to radiating patch 410, through contact 425. As shown in FIG. 4A, the delay line 415 is a meandering conductive line and may take on any shape so as to have sufficient length to generate the desired delay, thereby causing the desired phase shift in the RF signal.

The delay in the delay line 415 is controlled by the variable dielectric constant (VDC) plate 440 having variable dielectric constant material 444. While any manner for constructing the VDC plate 440 may be suitable for use with the embodiments of the antenna, as a shorthand in the specific embodiments the VDC plate 440 is shown consisting of upper binder 442, (e.g., dielectric layer such as glass PET, etc.) variable dielectric constant material 444 (e.g., twisted nematic liquid crystal layer), and bottom binder 446. In other embodiments one or both of the binder layers 442 and 444 may be omitted.

In some embodiments, e.g., when using twisted nematic liquid crystal layer, the VDC plate 440 also includes an alignment layer that may be deposited and/or glued onto the bottom of spacer 405, or be formed on the upper binder 442. The alignment layer may be a thin layer of material, such as polyimide-based PVA, that is being rubbed or cured with UV in order to align the molecules of the LC at the edges of confining substrates.

The effective dielectric constant of VDC plate 440 can be controlled by applying DC potential across the VDC plate 440. For that purpose, electrodes are formed and are connected to controllable voltage potential. In other embodiments, the DC potential is applied to the delay line 415, so that the delay line itself serves as an electrode. Thus, herein the term electrode would mean a separately formed electrodes or the delay line itself when it is connected to DC potential. In the arrangement shown in FIG. 4B, two electrodes 443 and 447 and provided one on the bottom surface of the upper binder 442 and one on the upper surface of the bottom binder 446. As one example, electrode 447 is shown connected to variable voltage potential 441, while electrode 443 is connected to ground. As one alternative, shown in broken line, electrode 443 may also be connected to a variable potential 449. Thus, by changing the output voltage of variable potential 441 and/or variable potential 449, one can change the dielectric constant of the VDC material in the vicinity of the electrodes 443 and 447, and thereby change the RF signal traveling over delay line 415. Changing the output voltage of variable potential 441 and/or variable potential 449 can be done using a controller, Ctl, running a software that causes the controller to output the appropriate control signal to set the appropriate output voltage of variable potential 441 and/or variable potential 449. When the supply of DC potential 441 to the electrodes is interrupted or reduced, the controller simultaneously sends the control signals to the valves (e.g., 235A and 235B) to open, as described above, so as to flow VDC material within the VDC plate 440—as illustrated by the block arrows. Thus, the antenna's performance and characteristics can be controlled using software—hence software-controlled antenna.

At this point it should be clarified that in the subject description the use of the term ground refers to both the generally acceptable ground potential, i.e., earth potential, and also to a common or reference potential, which may be a set potential or a floating potential. Similarly, while in the drawings the symbol for ground is used, it is used as shorthand to signify either an earth or a common potential, interchangeably. Thus, whenever the term ground is used herein, the term common or reference potential, which may be set or floating potential, is included therein.

As with all RF antennas, reception and transmission are symmetrical, such that a description of one equally applies to the other. In this description it may be easier to explain transmission, but reception would be the same, just in the opposite direction.

In transmission mode the RF signal is applied to the feed line 460 via connector 465 (e.g., a coaxial cable connector). As shown in FIG. 4B, there is no electrical DC connection between the feed line 460 and the delay line 415. However, in disclosed embodiments the layers are designed such that an RF short is provided between the feed line 460 and delay line 415. As illustrated in FIG. 4B, a backplane conductive ground (or common) 455 is formed on the top surface of backplane insulator (or dielectric) 450 or the bottom surface of bottom binder 446. The back plane conductive ground 455 is generally a layer of conductor covering the entire area of the antenna array. At each RF feed location, a window (DC break) 453 is provided in the back plane conductive ground 355 in alignment with the corresponding delay line. The RF signal travels from the feed patch 460, via the window 453, and is coupled to the delay line 415. The reverse happens during reception. Thus, a DC open and an RF short are formed between delay line 415 and feed patch 460. In one example the back plane insulator 450 is made of a Rogers® (FR-4 printed circuit board) and the feed patch 460 may be a conductive line formed on the Rogers. As explained in the above cited patents, when the illustrated structure is implemented as an antenna, each transmission line is coupled to a corresponding radiator of the array of radiators and the focusing and steering of the array is done by controlling the characteristics of the transmission in each transmission line by controlling the dielectric constant of the VDC at each delay line location. That is, the orientation of the director localized to the area under each delay line is controlled by applying voltage potential to the delay line, the electrodes, or to both.

It goes without saying that the embodiments and features disclosed herein are suitable for any device that uses alignment of molecules to generate material effect. For example, LCD televisions utilize the alignment of the liquid crystal molecules to control the light passing to the screen, thereby generating the desired image. Here again, the on-setting of the molecules is controlled by a potential applied to control lines, but the off-setting of the molecules is done by simply removing the potential and relying on the tendency of the molecules to assume the relaxed state by a chemical process. Thus, the turning off action is slower than the turning on action. However, by utilizing the embodiments and features disclosed herein, it is possible to drastically accelerate the turning off time of the molecules, thus enabling faster change of the image, which is beneficial especially for fast changing video, such as for sport events or action scenes.

The processes and techniques described herein are not inherently related to any particular apparatus and may be implemented by any suitable combination of components. Further, various types of general-purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. An orientable domain system, comprising:
an orientable domain fluid encased within an encasement;
an inlet port formed the encasement and oriented to inject orientable domain fluid into the encasement; and,
an outlet port formed in the encasement and oriented to eject orientable domain fluid from the encasement.

2. The system of claim 1, further including an inlet valve controlling flow into the inlet port and an outlet valve controlling flow out of the outlet port.

3. The system of claim 2, further comprising:
an orientable domain fluid reservoir;
a supply line coupled between the orientable domain fluid reservoir and the inlet port;
a return line coupled between the orientable domain fluid reservoir and the outlet port; and
a pump maintaining pressure differential between the supply line and the return line.

4. The system of claim 3, further comprising an inlet duck coupled to the inlet port and an outlet port coupled to the outlet port.

5. The system of claim 4, wherein the inlet port comprises a plurality of inlet slots and the outlet port comprises a plurality of outlet slots.

6. The system of claim 4, wherein the encasement comprises a top plate and a bottom plate, and further comprising an electric field applicator generating electric field between the top plate and the bottom plate.

7. The system of claim 6, wherein the electric field applicator comprises a common potential plate positioned under the bottom plate and a conductor positioned over the top plate.

8. An electronic transmission device transmitting electrical signals, comprising:
a variable dielectric constant (VDC) plate comprising VDC material sandwiched between a bottom dielectric plate and a top dielectric plate, the VDC material having plurality of orientable domains;
a common potential plate positioned below the bottom dielectric plate;
a plurality of delay lines positioned above the top dielectric plate, each delay line transmitting RF signals; and
at least one hydraulic input port enabling injection of VDC fluid into the VDC plate and at least one hydraulic output port enabling ejection of VDC fluid out of the VDC plate.

9. The device of claim 8, further comprising a plurality of radiators, each radiator paired with one of the plurality of delay lines.

10. The device of claim 8, wherein the at least one hydraulic input port comprises one or more inlet slots formed in one of the bottom dielectric plate and top dielectric plate, and the at least one hydraulic output port comprises one or more outlet slots formed in one of the bottom dielectric plate and top dielectric plate.

11. The device of claim 8, further comprising an inlet valve coupled to the inlet port and an outlet valve coupled to the outlet port.

12. The device of claim 8, further comprising an inlet duct provided over the inlet port and enabling fluid flow from the inlet duct through the inlet port; and an outlet duct provided over the outlet port and enabling fluid flow from the outlet port through the outlet duct.

13. An antenna, comprising:
a variable dielectric constant (VDC) plate having an inlet port enabling flow of VDC material into the VDC plate, and an outlet port enabling flow of VDC material out of the VDC plate;
a plurality of RF radiators arranged as an array above the VDC plate;
a plurality of delay lines, each coupled to and communicating RF signal with a corresponding one of the plurality of RF radiators;
an inlet fluid line coupled to the inlet port and an outlet fluid line coupled to the outlet port; and,
a pump maintaining a pressure differential between the inlet fluid line and outlet fluid line.

14. The antenna of claim 13, further comprising an inlet duct provided over the inlet port and enabling fluid flow from the inlet duct through the inlet port; and an outlet duct provided over the outlet port and enabling fluid flow through the outlet port into the outlet duct.

15. The antenna of claim 13, further comprising inlet conduit coupled to the inlet port and an outlet conduit coupled to the outlet port.

16. The antenna of claim 15, further comprising an inlet valve controlling fluid flow into the inlet conduit and an outlet valve controlling fluid flow out of the outlet conduit.

17. The antenna of claim 16, further comprising a pump maintaining a pressure differential between the inlet conduit and the outlet conduit.

18. The antenna of claim 17, wherein the pump maintains the pressure differential at from 0.1 to 1.5 bars, inclusive.

19. The antenna of claim 18, further comprising a reservoir in fluid communication with the pump.

20. The antenna of claim 18, wherein the VDC material has dynamic viscosity of from 9 up to and including 50 mPa*s (millipascal-second) at 60° C.

21. The antenna of claim 13, wherein the input port comprises a plurality of inlet slots formed in VDC plate, and the output port comprises a plurality of outlet slots formed in the VDC plate.

22. A method of operating a transmission device having conductors provided over a variable dielectric constant (VDC) plate is disclosed, comprising:
applying communication signals to at least a first subset of the conductors to cause transmission of the communication signals;
applying control signals to at least a second subset of the conductors to cause domains within the variable dielectric constant plate to align according to field generated by the control signals;
stopping application of the control signals to thereby cause the domain to relax to natural orientation, while simultaneously causing fluid flow within the VDC plate to thereby accelerate time required for the domains to relax to natural orientation.

23. The method of claim 22, wherein causing fluid flow comprises injecting VDC material into an inlet port formed in the VDC plate, while simultaneously injecting VDC material out of an outlet port formed in the VDC plate.

24. The method of claim 23, further comprising operating a pump to maintain pressure upstream of an inlet valve coupled to the inlet port higher than pressure downstream of an outlet port coupled to the outlet port.

25. The method of claim 24, wherein causing fluid flow comprises sending activation signals to the inlet valve and the outlet valve.

26. The method of claim 25, wherein causing fluid flow comprises opening the inlet valve and outlet valve for a duration of from 0.01 milliseconds to 0.5 seconds, inclusive.

27. The method of claim 26, comprising opening the inlet valve and outlet valve to flow rate of 0.1-10 cc/second inclusive.
